(19) United States
(12) Patent Application Publication
(10) Pub. No.: US 2002/0147126 A1
(43) Pub. Date: Oct. 10, 2002

(54) Cotton fabric with durable properties

(75) Inventors: Mark Robert Sivik, Mason, OH (US); Bruno Albert Hubesch, Neerijse (BE); An Bernaerts, Sint-Katelijne-Waver (BE); David Malcolm Lewis, West Yorkshire (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/109,231

(22) Filed: Mar. 28, 2002

Related U.S. Application Data
(63) Continuation of application No. PCT/US00/26512, filed on Sep. 27, 2000.
(60) Provisional application No. 60/157,161, filed on Sep. 30, 1999.

(51) Int. Cl. C11D 1/00; D06M 10/00

(52) U.S. Cl. 510/499; 8/115.51

(57) ABSTRACT

The present invention relates to compositions and a process which utilizes said compositions for providing cellulosic fabric and cellulosic fabric blends with durable press, said process comprising the steps of contacting fabric with a comprising:

a) from about 0.1% to about 20% by weight, of a cellulose modifying compound having the formula:

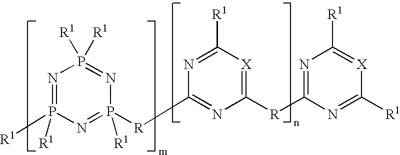

wherein R is a backbone linking unit; each R¹ is independently

i) a cellulose reactive moiety;

ii) a polysaccharide unit;

iii) s-triazine units having the formula:

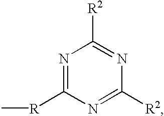

iv) pyrimidine units having the formula:

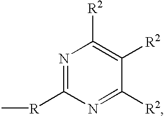

v) cyclotriphosphazene units having the formula:

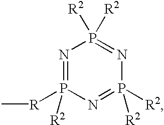

vi) and mixtures thereof;

wherein R² is hydrogen, C₁-C₄ alkyl, or R¹; X is —N—, —CH—, or mixtures thereof;

the index m is from 0 to 5, the index n is from 0 to 5;

b) from about 0.01% to about 10% by weight, of a crosslinking catalyst; and

c) the balance carriers and other adjunct ingredients.

The compositions of the present invention can take the form of laundry detergent compositions, fabric post-laundry spray-on compositions, and the like.

This application is a continuation under 35 USC §120 of PCT International Application Serial No. US00/26512, filed Sep. 27, 2000, published in accordance with PCT article 21(2) in English, which claims priority to Provisional Application Serial No. 60/157,161.

### FIELD OF THE INVENTION

The present invention relates to a method providing cellulosic fabric, inter alia, cotton with a durable press finish. The present invention further relates to compositions for use in the present process as well as cellulose fabric modifying compounds which provide a durable press finish.

### BACKGROUND OF THE INVENTION

Garments have been comprised of cotton fiber since antiquity and cotton continues to be a fabric of choice for many reasons. Cotton, a wholly natural fiber, is comprised of crosslinked cellulose the surface of which comprises an abundance of hydroxyl units which are chemically reactive. In fact, one negative against cotton fabric is the ability of materials which comprise stains to react with the cotton fabric rather than just become absorbed thereto. Cotton fabric is modified both in the mill and after it is formed into garments to contain one or more “finishes”, inter alia, optical brighteners, permanent press treatment. The consumer can readily delineate between a new garment which still exhibits the “fullness” and “crispness” in texture which has been applied by the manufacturer and an article of clothing which has been laundered several times and has now lost the “new” feel and appearance.

Typically, cotton clothing which is treated with anti-wrinkling agents or “stay-press” agents lose their fabric finish after several washes or in the case where fabric is chemically modified, the permanent press finish is greatly reduced over time due to mechanical wear and laundering. Ironing, especially ironing with additives, inter alia, starch, is one means by which the consumer attempts to re-new the crispness and fullness of new cotton fabric, however, starch must be re-applied after each wash. Post laundry treatments such as ironing involve a considerable amount of labor and, therefore, articles of clothing which would desirably have a “pressed” finish are not treated due to the extra work involved.

However, the consumer does not desire every article of clothing to have a permanent press finish or feel. Therefore, a laundry composition which affords all cotton comprising fabric with a permanent press finish would force the consumer to use two products; one which provides a permanent press benefit and one which does not.

There is a need in the art for a composition applied to fabric, inter alia, laundry detergent compositions, post laundry spray-on compositions, which provide a permanent press benefit to cotton fabric, including cotton blends, which can be exercised by the consumer.

### SUMMARY OF THE INVENTION

The present invention meets the aforementioned needs in that it has been surprisingly discovered that certain multifunctional cellulosic crosslinking agents which provide a permanent press benefit to clothing can be applied to cotton and cotton-like fabric during the laundry wash or rinse cycle wherein the crosslinking, and therefore the permanent press benefit, is selectively executed by the consumer after the laundry cycle has concluded. The crosslinking can be initiated by any means desired by the formulator, preferably by applying heat to the cotton garment, by ironing, inter alia.

The compositions of the present invention comprise a post laundry permanent press system, said system comprising one or more multifunctional triazines, triazine oligomers, pyrimidines, pyrimidine oligomers, cyclotriphosphazenes, cyclotriphosphazene oligomers, or mixtures there of, The post laundry permanent press system, once applied to fabric, may be executed immediately, or can be used at a time wherein the consumer desires to “re-fresh” the fabric. The durable press systems of the present invention are also suitable for application in the mill or after the fabric has been formed into an article of apparel. Preferably the systems of the present invention are applied to clothing comprising cellulosic material, including cellulosic blends, preferably 100% cotton.

The first aspect of the present invention relates to a process for providing fabric with durable press, said process comprising the steps of contacting fabric with a composition comprising:

a) from about 0.1%, preferably from about 1%, more preferably from about 3% to about 20%, preferably to about 10%, more preferably to about 7% by weight, of a cellulose modifying compound according to the present invention;

b) from about 0.01% to about 10% by weight, of a crosslinking catalyst; and

c) the balance carriers and other adjunct ingredients.

The present invention further relates to a composition for modifying fabric, said composition comprising:

a) from about 0.1% to about 20% by weight, of a cellulose modifying compound having the formula:

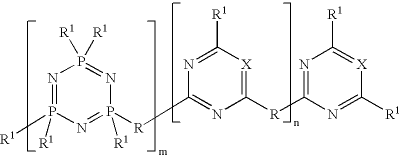

wherein R is a backbone linking unit; each R¹ is independently

i) a cellulose reactive moiety;

ii) a polysaccharide unit;

iii) s-triazine units having the formula:

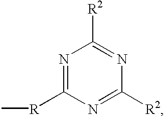

iv) pyrimidine units having the formula:

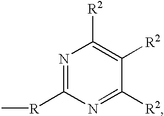

v) cyclotriphosphazene units having the formula:

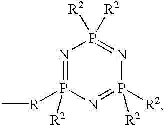

vi) and mixtures thereof;

wherein R² is hydrogen, C₁-C₄ alkyl, or R¹; X is —N—, —CH—, or mixtures thereof;

the index m is from 0 to 5, the index n is from 0 to 5;

b) from about 0.01% to about 10% by weight, of a crosslinking catalyst; and

c) the balance carriers and other adjunct ingredients.

These and other objects, features, and° advantages will become apparent to those of ordinary skill in the art from a reading of the following detailed description and the appended claims. All percentages, ratios and proportions herein are by weight, unless otherwise specified. All temperatures are in degrees Celsius (° C.) unless otherwise specified. All documents cited are in relevant part, incorporated herein by reference.

### DETAILED DESCRIPTION OF THE INVENTION

The present invention relates to the surprising discovery that semi-permanent, renewable, and re-freshable durable press can be effectively delivered to cotton fabric. A cellulosic material/durable press system comprising one or more compounds comprising:

i) a cellulosic fiber reactive crosslinking component;

ii) a crosslinking catalyst; and

iii) optionally, one or more fabric substantive components

can be applied to cellulose comprising fiber wherein said durable press compound reacts with the hydroxyl moieties of the cotton fiber and crosslinks between cotton fibers providing a permanent press benefit to the cellulosic material.

The following depicts an example of the application of a durable press system according to the present invention onto cotton fabric.

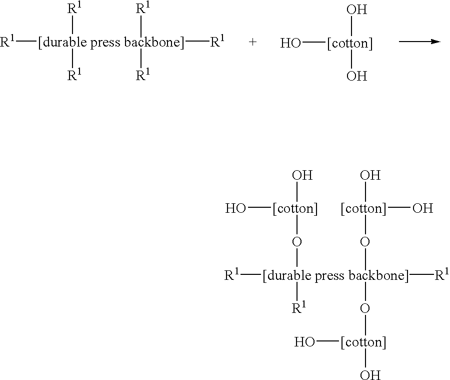

Once attached to the cotton fabric via the R¹ cellulose reactive units, the compound provides durable press benefits until the bonds are broken, for example, by mechanical means (wearing).

For the purposes of the present invention the term “durable” is defined as “a compound which provides a fabric benefit, inter alia, smoothness, when applied to fabric in a manner wherein said compound is covalently linked to the fabric and does not become detached for reasons other than mechanical loss”. For example, a compound according to the present invention which is applied to cellulosic fabric will not transfer to a second surface due to contact with said second surface. Instead the compound which provides the benefit remains associated with the fabric surface. The term “durable” also connotes the fact that if by a mechanical process, inter alia, wearing of the fabric, one or more “reactive units” no longer form a covalent bond with the bulk of the fiber, non-reacted “reactive units” can be activated by the consumer thereby re-bonding the compound to the fabric.

For the purposes of the present invention the term “semi-permanent” as it relates to the attachment of the present compounds to cotton fabric, is defined as “durable fabric enhancement compounds which are capable of permanently reacting with one or more hydroxyl units of cellulosic fabric wherein the compound is subsequently lost from the fabric surface due to wear or other type of mechanical action not involving the specific breaking of the cellulose reactive unit-cellulose fabric covalent chemical bonds”.

For the purposes of the present invention the term “renewable” relates to the fact that the compounds of the present invention can be continuously re-applied and/or re-fixed to the fabric at any point in the “process of use”. The “process of use” is defined as “any step which uses the an article of manufacture comprised of cotton, typically extending from the time of purchase until the article is discarded”. Non-limiting examples of steps which comprise the “process of use” include, wearing of an article of manufacture comprise cotton, inter alia, as an article of apparel; care of the article, inter alia, laundering fabric, pre-soaking; “refreshing fabric”, inter alia, spraying with a composition of the present invention for the purpose of providing a fabric enhancement benefit, re-ironing fabric once the fabric has been worn but prior to re-laundering.

For the purposes of the present invention the term “re-freshable” is defined as “a fabric enhancement compound which remains attached or affixed to fabric and which is capable of further reacting at a subsequent time with additional hydroxyl units of cellulose to provide a subsequent durable fabric benefit”. “Re-freshable” is an aspect of the compounds “durability”. “Re-freshable” relates to the aspect of the present invention wherein between laundry cycles the compounds of the present invention may be applied to the cellulosic material to re-enforce the desired benefit. It is a preferred embodiment of the present invention to apply in a first step the durable fabric enhancement system of the present invention to cellulosic fabric, in a second step to fix the components which comprise said system to said cellulosic fabric, and in a third step to re-form new covalent bonds between unreacted cellulose reactive units and cellulose hydroxyl units.

For the purposes of the present invention the term “cellulosic material” is defined as “fibrous cellulose comprising-material derived from native sources, inter alia, cotton, rayon, flax, including the pulp of said sources, inter alia, wood pulp; cellulose comprising derivatives, non-limiting examples of which include cellulose acetates, cellulose ethers”. “Cellulosic material” depending upon the context is defined as “the raw material, inter alia, fibers, or the finished product, inter alia, an article of clothing”. The term “cellulose fabric” is used interchangeably for and is meant to stand equally well for “fabric comprising 100% cotton fiber, and mixtures of cotton fiber and synthetic fibers”.

The durable press compounds of the present invention which comprise the cellulosic fabric modifying systems have a modulated reactivity toward cellulosic fabric. As set forth hereinabove, the compounds of the present invention react with the hydroxyl moieties which comprise cellulose and provides a rigid link or framework which holds the sections of cellulose fibers together to form a permanent press or durable fabric finish. For example, a mono-triazine compound will have three cellulose reactive sites. Once one site reacts with the fabric, the two remaining sites will then be available to react with proximal hydroxyl units and form a rigid framework resulting in a durable press finish. The present invention, however, allows the formulator to react, in the s-triazine example, one of the remaining sites with a non-reactive moiety (for example, a non-leaving group) thereby modulating the amount of “stiffness” that the compound will provide to the substrate fabric. Also by the choice of cellulose reactive units the formulator can modulate the relative reactivity of the units toward cellulosic material. For the purposes of the present invention, in the case wherein an oligomeric backbone comprises the several differentiated reactivity R¹ cellulose reactive units, the most reactive may initially combine with cellulosic fiber and the balance may remain unreacted so as to be initiated to react with cellulose hydroxyl units in the future to provide a “durable fabric press benefit”.

Durable Press Systems

The compositions of the present invention comprise from about 0.1%, preferably from about 1%, more preferably from about 3% to about 20%, preferably to about 10%, more preferably to about 7% by weight, of one or more cellulose modifying compounds.

The compositions of the present invention comprise and the processes of the present invention utilize compositions which comprise one or more fabric modifying compounds having the formula:

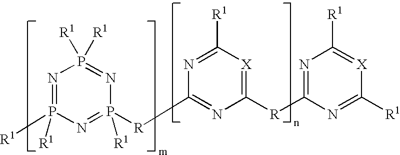

wherein R is a backbone linking unit wherein each R is independently a unit having the formula:

—(Y)ₚR³(Y)ₚ—

wherein R³ is substituted or unsubstituted C₁-C₂₂ alkylene, C₁-C₂₂ alkenylene, C₃-C₂₂ cycloalkylene, C₆-C₂₂ arylene, C₇-C₂₂ alkylarylene, and mixture thereof; preferably R³ is C₂-C₆ alkylene, phenylene, C₇-C₁₀ alkylarylene, and mixture thereof. Y is —O—, NR′—, and mixtures thereof, R′ is hydrogen, C₁-C₄ alkyl, and mixtures thereof; p is 0 or 1. Preferably Y is —NH— when each p is 1.

Each R¹is independently selected from the group consisting of:

i) a cellulose reactive moiety. The term “cellulose reactive moiety” is defined herein as “a unit which facilitates the formation of a covalent bond between the cellulose modifying compound and a hydroxyl unit comprising the cellulosic fabric.” Preferably each cellulose reactive moiety is independently selected from the group consisting of halogen, thioglycolate, citrate, nicotinate, (4-sulfonylphenyl)amino, (4-sulfonylphenyl)oxy, and mixtures thereof; more preferably chlorine, (4-sulfonylphenyl)amino, (4-sulfonylphenyl)oxy, most preferably chlorine.

ii) a polysaccharide unit. The term “polysaccharide unit” is defined herein as “saccharide units, including polysucrose, polyglucose, chitosan, and the like, or other cellulosic-like units having an increased affinity for cellulosic and cellulosic fiber comprising fabric.” A preferred polysaccharide includes chitosan.

iii) s-triazine units having the formula:

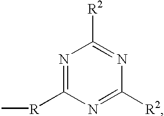

iv) pyrimidine units having the formula:

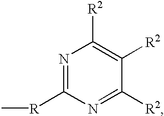

v) cyclotriphosphazene units having the formula:

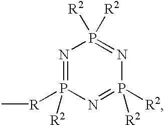

vi) and mixtures thereof;

wherein R² is hydrogen, C₁-C₄ alkyl, or R¹; X is —N—, —CH—, and mixtures thereof, preferably —N—; the index m is from 0 to 5, the index n is from 0 to 5.

For embodiments wherein R¹ units comprise one or more s-triazine, pyrimidine, or cyclotriphosphazene units, the backbone of the oligomer will be a branched backbone, for example, a backbone having the general formula:

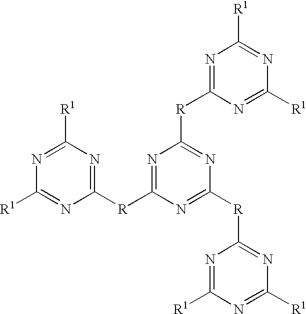

wherein R units are any linking units as described hereinabove, and the R¹ units are cellulose reactive units as described herein.

Another embodiment of the present invention relates to compounds, compositions comprising compounds, or processes utilizing compounds having two s-triazine or pyrimidine backbone units (oligomers), for example, the preferred compounds having the formula:

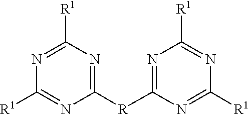

wherein R has the formula:

—NH—R³—NH—

wherein R³ is C₂-C₆ alkylene, phenylene, substituted phenylene, and mixtures thereof; and R¹ is selected from the group consisting of halogen, (4-sulfonyl-phenyl)amino, (4-sulfonylphenyl)oxy, and mixtures thereof.

Non-limiting examples of cellulose modifying compounds include compounds having the general formula:

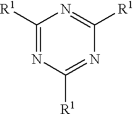

wherein R¹ is a fabric reactive moiety selected from the group consisting of halogen, thioglycolate, citrate, nicotinate, (4-sulfonylphenyl)amino, (4-sulfonylphenyl)oxy, and mixtures thereof, as exemplified by the compound having the formula:

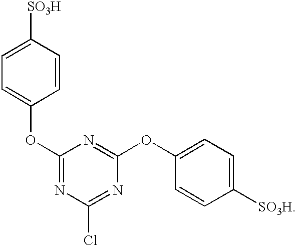

Non-limiting examples of multiple backbone unit comprising cellulose modifying compounds include compounds having the general formula:

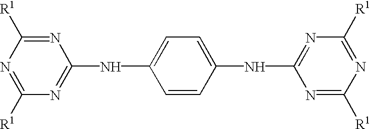

wherein R¹ is a fabric reactive moiety selected from the group consisting of halogen, thioglycolate, citrate, nicotinate, (4-sulfonylphenyl)amino, (4-sulfonylphenyl)oxy, and mixtures thereof; as represented by a cellulose modifying compound having the formula:

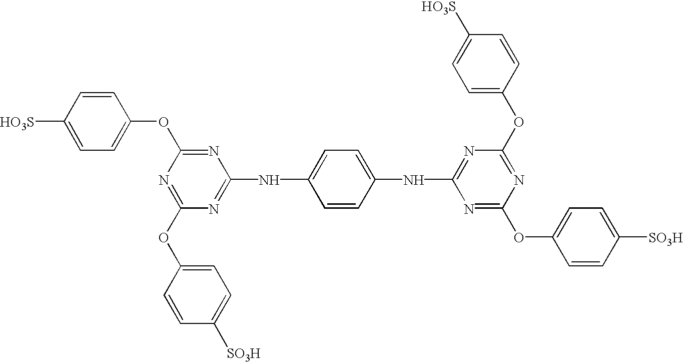

or a compound having the formula:

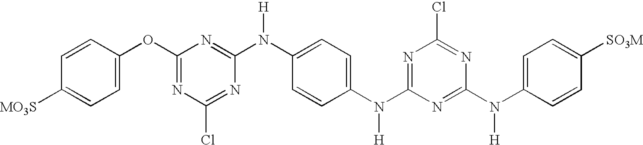

wherein M is hydrogen of a water soluble cation, preferably sodium, potassium, ammonium, and mixtures thereof.

The following are preferred durable press compounds according to the present invention.

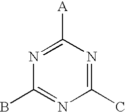

| A | B | C |
|---|---|---|
| chloro | chloro | di(2-hydroxyethyl)amino |
| chloro | chloro | 4-sulphonylphenoxy |
| chloro | 4-sulphonylphenoxy | 4-sulphonylphenoxy |
| chloro | chloro | 3-methyl-4- |
| | | sulphonylphenoxy |
| chloro | chloro | 2,3,4,5-tetrahydroxy- |
| | | aminopentane |
| chloro | chloro | 2-sulphonylethaneamino |
| chloro | chloro | 2-sulphonylethoxy |

### Formulations

The present invention relates to a composition for modifying cellulose or cellulose comprising fabric, said composition comprising:

a) from about 0.1%, preferably from about 1%, more preferably from about 3% to about 20%, preferably to about 10%, more preferably to about 7% by weight, of a cellulose modifying compound as described herein above;

b) from about 0.01% to about 10% by weight, of a crosslinking catalyst; and

c) the balance carriers and other adjunct ingredients.

Crosslinking Catalyst

The compositions of the present invention which are applied to fabric at the point of manufacture by the process of the present invention comprises from about 0.01%, preferably from about 0.1%, more preferably from about 1% to about 10%, preferably to about 7%, more preferably to about 5% by weight, of a crosslinking catalyst. Preferably said crosslinking catalyst is a base selected from the group consisting of alkali metal carbonates, alkaline earth metal carbonates, alkali metal hydroxides, alkaline earth metal hydroxides, and mixtures thereof. More preferred catalyst is sodium carbonate, sodium bicarbonate, and mixtures thereof.

### Adjunct Ingredients

Aside from the requirement that the compositions of the present invention comprise a cellulose modifying compound and a crosslinking catalyst, the balance of the composition may comprise one or more adjunct ingredients as well as carriers. The following are non-limiting examples of carriers and preferred adjunct ingredients.

Fabric Softening Actives

The compositions of the present invention optionally comprise at least about 1%, preferably from about 10%, more preferably from about 20% to about 80%, more preferably to about 60%, most preferably to about 45% by weight, of the composition of one or more fabric softener actives.

The preferred fabric softening actives according to the present invention are amines having the formula:

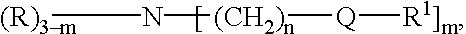

quaternary ammonium compounds having the formula:

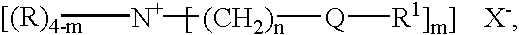

and mixtures thereof, wherein each R is independently C₁-C₆ alkyl, C₁-C₆ hydroxyalkyl, benzyl, and mixtures thereof; R¹ is preferably C₁₁-C₂₂ linear alkyl, C₁₁-C₂₂ branched alkyl, C₁₁-C₂₂ linear alkenyl, C₁₁-C₂₂ branched alkenyl, and mixtures thereof; Q is a carbonyl moiety independently selected from the units having the formula:

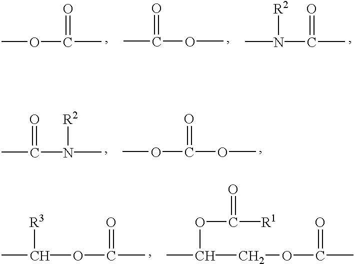

wherein R² is hydrogen, C₁-C₄ alkyl, preferably hydrogen; R³ is C₁-C₄ alkyl, preferably hydrogen or methyl; preferably Q has the formula:

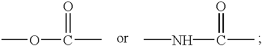

X is a softener compatible anion, preferably the anion of a strong acid, for example, chloride, bromide, methylsulfate, ethylsulfate, sulfate, nitrate and mixtures thereof, more preferably chloride and methyl sulfate. The anion can also, but less preferably, carry a double charge, in which case X⁽⁻⁾ represents half a group. The index m has a value of from 1 to 3; the index n has a value of from 1 to 4, preferably 2 or 3, more preferably 2.

One embodiment of the present invention provides for amines and quaternized amines having two or more different values for the index n per molecule, for example, a softener active prepared from the starting amine methyl(3-aminopropyl)(2-hydroxyethyl)amine.

More preferred softener actives according to the present invention have the formula:

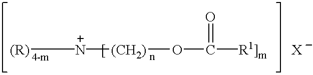

wherein the unit having the formula:

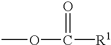

is a fatty acyl moiety. Suitable fatty acyl moieties for use in the softener actives of the present invention are derived from sources of triglycerides including tallow, vegetable oils and/or partially hydrogenated vegetable oils including inter alia canola oil, safflower oil, peanut oil, sunflower oil, corn oil, soybean oil, tall oil, rice bran oil. Yet more preferred are the Diester Quaternary Ammonium Compounds (DEQA's) wherein the index m is equal to 2.

The formulator, depending upon the desired physical and performance properties of the final fabric softener active, can choose any of the above mentioned sources of fatty acyl moieties, or alternatively, the formulator can mix sources of triglyceride to form a “customized blend”. However, those skilled in the art of fats and oils recognize that the fatty acyl composition may vary, as in the case of vegetable oil, from crop to crop, or from variety of vegetable oil source to variety of vegetable oil source. DEQA's which are prepared using fatty acids derived from natural sources are preferred.

A preferred embodiment of the present invention provides softener actives comprising R¹ units which have at least about 3%, preferably at least about 5%, more preferably at least about 10%, most preferably at least about 15% C₁₁-C₂₂ alkenyl, including polyalkenyl (polyunsaturated) units inter alia oleic, linoleic, linolenic.

For the purposes of the present invention the term “mixed chain fatty acyl units” is defined as “a mixture of fatty acyl units comprising alkyl and alkenyl chains having from 10 carbons to 22 carbon atoms including the carbonyl carbon atom, and in the case of alkenyl chains, from one to three double bonds, preferably all double bonds in the cis configuration”. With regard to the R¹ units of the present invention, it is preferred that at least a substantial percentage of the fatty acyl groups are unsaturated, e.g., from about 25%, preferably from about 50% to about 70%, preferably to about 65%. The total level of fabric softening active containing polyunsaturated fatty acyl groups can be from about 3%, preferably from about 5%, more preferably from about 10% to about 30%, preferably to about 25%, more preferably to about 18%. As stated herein above cis and trans isomers can be used, preferably with a cis/trans ratio is of from 1:1, preferably at least 3:1, and more preferably from about 4:1 to about 50:1, more preferably about 20:1, however, the minimum being 1:1.

The level of unsaturation contained within the tallow, canola, or other fatty acyl unit chain can be measured by the Iodine Value (IV) of the corresponding fatty acid, which in the present case should preferably be in the range of from 5 to 100 with two categories of compounds being distinguished, having a IV below or above 25.

Indeed, for compounds having the formula:

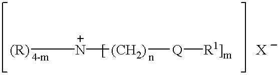

derived from tallow fatty acids, when the Iodine Value is from 5 to 25, preferably 15 to 20, it has been found that a cis/trans isomer weight ratio greater than about 30/70, preferably greater than about 50/50 and more preferably greater than about 70/30 provides optimal concentrability.

For compounds of this type made from tallow fatty acids having a Iodine Value of above 25, the ratio of cis to trans isomers has been found to be less critical unless very high concentrations are needed. A further preferred embodiment of the present invention comprises DEQA's wherein the average Iodine Value for R¹ is approximately 45.

The R¹ units suitable for use in the isotropic liquids present invention can be further characterized in that the Iodine Value (IV) of the parent fatty acid, said IV is preferably from about 10, more preferably from about 50, most preferably from about 70, to a value of about 140, preferably to about 130, more preferably to about 115. However, formulators, depending upon which embodiment of the present invention they choose to execute, may wish to add an amount of fatty acyl units which have Iodine Values outside the range listed herein above. For example, “hardened stock” (IV less than or equal to about 10) may be combined with the source of fatty acid admixture to adjust the properties of the final softener active.

A prefered source of fatty acyl units, especially fatty acyl units having branching, for example, “Guerbet branching”, methyl, ethyl, etc. units substituted along the primary alkyl chain, synthetic sources of fatty acyl units are also suitable. For example, the formulator may with to add one or more fatty acyl units having a methyl branch at a “non-naturally occuring” position, for example, at the third carbon of a C₁₇ chain. What is meant herein by the term “non-naturally occuring” is “acyl units whihc are not found in significant (greater than about 0.1%) quantities is common fats and oils which serve as feedstocks for the source of triglycerides described herein.” If the desired branched chain fatty acyl unit is unavailable from readily available natural feedstocks, therefore, synthetic fatty acid can be suitably admixed with other synthetic materials or with other natural triglyceride derived sources of acyl units.

The following are examples of preferred softener actives according to the present invention.

N,N-di(tallowyl-oxy-ethyl)-N,N-dimethyl ammonium chloride;

N,N-di(canolyl-oxy-ethyl)-N,N-dimethyl ammonium chloride;

N,N-di(tallowyl-oxy-ethyl)-N-methyl, N-(2-hydroxyethyl) ammonium methyl sulfate;

N,N-di(canolyl-oxy-ethyl)-N-methyl, N-(2-hydroxyethyl) ammonium methyl sulfate;

N,N-di(tallowylamidoethyl)-N-methyl, N-(2-hydroxyethyl) ammonium methyl sulfate;

N,N-di(2-tallowyloxy-2-oxo-ethyl)-N,N-dimethyl ammonium chloride;

N,N-di(2-canolyloxy-2-oxo-ethyl)-N,N-dimethyl ammonium chloride;

N,N-di(2-tallowyloxyethylcarbonyloxyethyl)-N,N-dimethyl ammonium chloride;

N,N-di(2-canolyloxyethylcarbonyloxyethyl)-N,N-dimethyl ammonium chloride;

N-(2-tallowoyloxy-2-ethyl)-N-(2-tallowyloxy-2-oxo-ethyl)-N,N-dimethyl ammonium chloride;

N-(2-canolyloxy-2-ethyl)-N-(2-canolyloxy-2-oxo-ethyl)-N,N-dimethyl ammonium chloride;

N,N,N-tri(tallowyl-oxy-ethyl)-N-methyl ammonium chloride;

N,N,N-tri(canolyl-oxy-ethyl)-N-methyl ammonium chloride;

N-(2-tallowyloxy-2-oxoethyl)-N-(tallowyl)-N,N-dimethyl ammonium chloride;

N-(2-canolyloxy-2-oxoethyl)-N-(canolyl)-N,N-dimethyl ammonium chloride;

1,2-ditallowyloxy-3-N,N,N-trimethylammoniopropane chloride; and

1,2-dicanolyloxy-3-N,N,N-trimethylammoniopropane chloride;

and mixtures of the above actives.

Particularly preferred is N,N-di(tallowoyl-oxy-ethyl)-N,N-dimethyl ammonium chloride, where the tallow chains are at least partially unsaturated and N,N-di(canoloyl-oxy-ethyl)-N,N-dimethyl ammonium chloride, N,N-di(tallowyl-oxy-ethyl)-N-methyl, N-(2-hydroxyethyl) ammonium methyl sulfate; N,N-di(canolyl-oxy-ethyl)-N-methyl, N-(2-hydroxyethyl) ammonium methyl sulfate; and mixtures thereof.

Additional fabric softening agents useful herein are described in U.S. Pat. No. 5,643,865 Mermelstein et al., issued Jul. 1, 1997; U.S. Pat. No. 5,622,925 de Buzzaccarini et al., issued Apr. 22, 1997; U.S. Pat. No. 5,545,350 Baker et al., issued Aug. 13, 1996; U.S. Pat. No. 5,474,690 Wahl et al., issued Dec. 12, 1995; U.S. Pat. No. 5,417,868 Turner et al., issued Jan. 27, 1994; U.S. Pat. No. 4,661,269 Trinh et al., issued Apr. 28, 1987; U.S. Pat. No. 4,439,335 Burns, issued Mar. 27, 1984; U.S. Pat. No. 4,401,578 Verbruggen, issued Aug. 30, 1983; U.S. Pat. No. 4,308,151 Cambre, issued Dec. 29, 1981; U.S. Pat. No. 4,237,016 Rudkin et al., issued Oct. 27, 1978; U.S. Pat. No. 4,233,164 Davis, issued Nov. 11, 1980; U.S. Pat. No. 4,045,361 Watt et al., issued Aug. 30, 1977; U.S. Pat. No. 3,974,076 Wiersema et al., issued Aug. 10, 1976; U.S. Pat. No. 3,886,075 Bernadino, issued May 6, 1975; U.S. Pat No. 3,861,870 Edwards et al., issued Jan. 21 1975; and European Patent Application publication No. 472,178, by Yamamura et al., all of said documents being incorporated herein by reference.

Crystal Growth Inhibitor

The compositions of the present invention optionally comprise from about 0.005%, preferably from about 0.5%, more preferably from about 0.1% to about 1%, preferably to about 0.5%, more preferably to about 0.25%, most preferably to about 0.2% by weight, of one or more crystal growth inhibitors.

Carboxylic Compounds

Non-limiting examples of carboxylic compounds which serve as crystal growth inhibitors include glycolic acid, phytic acid, polycarboxylic acids, polymers and co-polymers of carboxylic acids and polycarboxylic acids, and mixtures thereof. The inhibitors may be in the acid or salt form. Preferably the polycarboxylic acids comprise materials having at least two carboxylic acid radicals which are separated by not more than two carbon atoms (e.g., methylene units). The preferred salt forms include alkali metals; lithium, sodium, and potassium; and alkanolammonium. The polycarboxylates suitable for use in the present invention are further disclosed in U.S. Pat. No. 3,128,287, No. 3,635,830, No. 4,663,071, No. 3,923,679; No. 3,835,163; No. 4,158,635; No. 4,120,874 and No. 4,102,903, each of which is included herein by reference.

Further suitable polycarboxylates include ether hydroxypolycarboxylates, polyacrylate polymers, copolymers of maleic anhydride and the ethylene ether or vinyl methyl ethers of acrylic acid. Copolymers of 1,3,5-trihydroxybenzene, 2,4,6-trisulphonic acid, and carboxymethyloxysuccinic acid are also useful. Alkali metal salts of polyacetic acids, for example, ethylenediamine tetraacetic acid and nitrilotriacetic acid, and the alkali metal salts of polycarboxylates, for example, mellitic acid, succinic acid, oxydisuccinic acid, polymaleic acid, benzene 1,3,5-tricarboxylic acid, carboxymethyloxysuccinic acid, are suitable for use in the present invention as crystal growth inhibitors.

The polymers and copolymers which are useful as crystal growth inhibitors have a molecular weight which is preferably greater than about 500 daltons to about 100,000 daltons, more preferably to about 50,000 daltons.

Examples of commercially available materials for use as crystal growth inhibitors include, polyacrylate polymers Good-Rite® ex BF Goodrich, Acrysol® ex Rohm & Haas, Sokalan® ex BASF, and Norasol® ex Norso Haas. Preferred are the Norasol® polyacrylate polymers, more preferred are Norasol® 410N (MW 10,000) and Norasol® 440N (MW 4000) which is an amino phosphonic acid modified polyacrylate polymer, and also more preferred is the acid form of this modified polymer sold as Norasol® QR 784 (MW 4000) ex Norso-Haas.

Polycarboxylate crystal growth inhibitors include citrates, e.g., citric acid and soluble salts thereof (particularly sodium salt), 3,3-dicarboxy-4-oxa-1,6-hexanedioates and related compounds further disclosed in U.S. Pat. No. 4,566,984 incorporated herein by reference, C₅-C₂₀ alkyl, C₅-C₂₀ alkenyl succinic acid and salts thereof, of which dodecenyl succinate, lauryl succinate, myristyl succinate, palmityl succinate, 2-dodecenylsuccinate, 2-pentadecenyl succinate, are non-limiting examples. Other suitable polycarboxylates are disclosed in U.S. Pat. No. 4,144,226, No. 3,308,067 and No. 3,723,322, all of which are incorporated herein by reference.

Organic Phosphonic Acids

Organic diphosphonic acid are also suitable for use as crystal growth inhibitors. For the purposes of the present invention the term “organic diphosphonic acid” is defined as “an organo-diphosphonic acid or salt which does not comprise a nitrogen atom”. Preferred organic diphosphonic acids include C₁-C₄ diphosphonic acid, preferably C₂ diphosphonic acid selected from the group consisting of ethylene diphosphonic acid, α-hydroxy-2 phenyl ethyl diphosphonic acid, methylene diphosphonic acid, vinylidene-1,1-diphosphonic acid, 1,2-dihydroxyethane-1,1-diphosphonic acid, hydroxy-ethane 1,1 diphosphonic acid, the salts thereof, and mixtures thereof. More preferred is hydroxyethane-1,1-diphosphonic acid (HEDP).

A more preferred phosphonic acid I 2-phosphonobutane-1,2,4-tricarboxylic acid (PBTC) available as Bayhibit® AM ex Bayer.

Electrolyte

The compositions of the present invention may also optionally, but preferably comprise, one or more electrolytes for control of phase stability, viscosity, and/or clarity. For example, the presence of certain electrolytes inter alia calcium chloride, magnesium chloride may be key to insuring initial product clarity and low viscosity, or may affect the dilution viscosity of liquid embodiments, especially isotropic liquid embodiments. Not wishing to be limited by theory, but only wishing to provide an example of a circumstance wherein the formulator must insure proper dilution viscosity, includes the following example. An electrolyte may be added to the compositions of the present invention to insure phase stability and prevent the fabric modifying compound from “gelling out” or from undergoing an undesirable or unacceptable viscosity increase. Prevention of gelling or formation of a “swelled”, high viscosity solution insures thorough delivery of the fabric modifying composition during the process of the present invention.

However, those skilled in the art of fabric softener compositions will recognize that the level of electrolyte is also influenced by other factors inter alia the type of fabric onto which the composition is deposed, the type of R¹ fabric reactive units and the final pH of the solution, the amount of principal solvent, and the level and type of nonionic surfactant. Therefore, the formulator must consider all of the ingredients, namely, fabric modifying compound, nonionic surfactant, and in the case of isotropic liquids, the principal solvent type and level, as well as level and identity of adjunct ingredients before selecting the type and/or level of electrolyte.

A wide variety of ionizable salts can be used. Examples of suitable salts are the halides of the Group IA and IIA metals of the Periodic Table of the elements, e.g., calcium chloride, sodium chloride, potassium bromide, and lithium chloride. The ionizable salts are particularly useful during the process of mixing the ingredients to make the compositions herein, and later to obtain the desired viscosity. The amount of ionizable salts used depends on the amount of active ingredients used in the compositions and can be adjusted according to the desires of the formulator. Typical levels of salts used to control the composition viscosity are from about 20 to about 10,000 parts per million (ppm), preferably from about 20 to about 5,000 ppm, of the composition.

Alkylene polyammonium salts can be incorporated into the composition to give viscosity control in addition to or in place of the water-soluble, ionizable salts above, In addition, these agents can act as scavengers, forming ion pairs with anionic detergent carried over from the main wash, in the rinse, and on the fabrics, and can improve softness performance. These agents can stabilized the viscosity over a broader range of temperature, especially at low temperatures, compared to the inorganic electrolytes. Specific examples of alkylene polyammonium salts include L-lysine, monohydrochloride and 1,5-diammonium 2-methyl pentane dihydrochloride.

Dispersibility Aids

When dispersibility aids are present, the total level is from 0.1%, preferably from 0.3%, more preferably from 3%, even more preferably from 4%, and most preferably from 5% to 25%, preferably to 17%, more preferably to 15%, most preferably to 13% by weight, of the composition. The total level of dispersibility aid includes any amount that may be present as part of another adjunct ingredient.

Preferred dispersibility aids are GENAMINE® and GENAPOL® ex Clariant. When PVP is present in the compositions of the present invention, a preferred embodiment comprises both a cocoyl ethoxylated amine and a cocoyl ethoxylated alcohol, wherein the ethoxylation is approximately 10, each of which are available as GENAMINE® and GENAPOL®. A preferred example of the use of this admixture is a composition which comprises, for example, 0.2% GENAMINE® and 0.1% GENAPOL®.

Principal Solvent

Although water is the preferred carrier of the present invention, the compositions of the present invention may comprise as a carrier a principal solvent. The level of principal solvent present in the compositions of the present invention is typically less than about 95%, preferably less than about 50%, more preferably less than about 25%, most preferably less than about 15% by weight. Some embodiments of present invention may comprise no principal solvent but may substitute instead a suitable nonionic surfactant as described herein above.

When utilized, the principal solvents suitable for use in the present invention are selected from those having a ClogP of from about 0.15 to about 1, preferably from about 0.15 to about 0.64, more preferably from about 0.25 to about 0.62, most preferably from about 0.4 to about 0.6. Preferably the principal solvent is at least to some degree an asymmetric molecule, preferably having a melting, or solidification point which allows the principal solvent to be liquid at or near room temperature. Low molecular weight principal solvents may be desirable for some embodiments. More preferred molecules are highly asymmetrical.

### Process

The present invention relates to a manufacturing process for providing fabric with an enhanced fabric benefit, said process comprising the steps of contacting fabric with a composition in the form of an aqueous emulsion, said composition comprising:

a) from about 0.1%, preferably from about 1%, more preferably from about 3% to about 20%, preferably to about 10%, more preferably to about 7% by weight, of a cellulose modifying compound as described herein above;

b) from about 0.01%, preferably from about 0.1%, more preferably from about 1% to about 10%, preferably to about 7%, more preferably to about 5% by weight, of a crosslinking catalyst; and

c) the balance carriers and other adjunct ingredients.

The following is a non-limiting example for preparing a cellulose modifying compound according to the present invention.

### EXAMPLE 1

### Preparation of 1,4-bis[4,6-di-(4-sulfophenyl)-1,3,5-triazinyl]phenylenediamine

Sodio 4-hydroxybenzene sulfonic acid (78.98 g, 0.33 mole) is charged to a 2-L 3-neck flask fitted with a mechanical stirrer and argon inlet tube. Water (456 g) is added and the solution stirred. Separately, cyanuric chloride (31.05 g, 0.167 mole) is dissolved in acetone (223 mL) and charged to an addition funnel. The initial pH of the sulfonic acid solution is 5.28. The cyanuric chloride solution is added dropwise while maintaining the pH between 3.5 and 4 by the intermittent addition of sufficient sodium bicarbonate (23.89 g). 1,4-Phenylenediamine (9.3 g, 0.083 mole) is dissolved in water (225 mL) and gently warmed. The aqueous solution of 1,4-phenylenediamine is then added dropwise to the stirred solution maintaining a temperature below 25° C. and a pH less than 5 by the alternate addition of aqueous sodium bicarbonate. The solution is stirred 18 hours and the pH adjusted to 5 using additional sodium bicarbonate. Potassium chloride (134 g) is added and the solution is filtered over celite to obtain the crude product which is isolated by standard procedures.

The following are non-limiting examples of the compositions of the present invention. The following can be directly sprayed onto fabric or the compositions can be incorporated into granular or liquid laundry detergent compositions, fabric softening compositions and the like.

TABLE I

| | weight % | | | | | | |
|---|---|---|---|---|---|---|---|
| Ingredients | 2 | 3 | 4 | 5 | 6 | 7 | 8 |
| Polymer¹ | 1.5 | 2 | 2.5 | 2 | — | — | — |
| Polymer² | — | — | — | — | 1.75 | 2 | 2 |
| Surfactant³ | — | — | — | 1.5 | — | — | — |
| Surfactant⁴ | — | — | — | — | — | — | 0.5 |
| Catalyst⁵ | 0.15 | 0.15 | 0.18 | 0.15 | — | — | — |
| Catalyst⁶ | — | — | — | — | 2.5 | 2.5 | 2.5 |
| Fabric softener⁷ | — | — | — | — | — | — | — |
| pH of final solution | 10.3 | 10.3 | 10.4 | 10.3 | 7.5 | 7.65 | 7.65 |
| Water & minors | bal- | bal- | bal- | bal- | bal- | bal- | bal- |
| | ance | ance | ance | ance | ance | ance | ance |

¹1,4-bis[4,6-di-(4-sulfophenyl)-1,3,5-triazinyl]phenylenediamine.
²2-chloro-4,6-di-(4-sulfophenyl)-1,3,5-triazine.
³Neodol 91-8.
⁴Neodol 13-5.
⁵Sodium carbonate.
⁶Sodium bicarbonate.
⁷Di-(tallowyl-oxy-ethyl) dimethyl ammonium chloride.

What is claimed is:

1. A process for providing fabric with durable press, said process comprising the steps of contacting fabric with a comprising:
a) from about 0.1% to about 20% by weight, of a cellulose modifying compound having the formula: 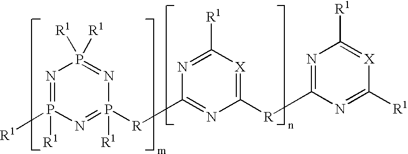
wherein R is a backbone linking unit; each R¹ is independently
i) a cellulose reactive moiety;
ii) a polysaccharide unit;
iii) s-triazine units having the formula: 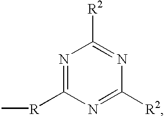
iv) pyrimidine units having the formula: 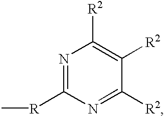
v) cyclotriphosphazene units having the formula: 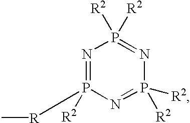
vi) and mixtures thereof;
wherein R² is hydrogen, C₁-C₄ alkyl, or R¹; X is —N—, —CH—, or mixtures thereof;
the index m is from 0 to 5, the index n is from 0 to 5;
b) from about 0.01% to about 10% by weight, of a crosslinking catalyst; and
c) the balance carriers and other adjunct ingredients.

2. A process according to claim 1 wherein each R is independently a unit having the formula:
—(Y)ₚR³(Y)ₚ—
wherein R³ is C₁-C₂₂ alkylene, C₁-C₂₂ alkenylene, C₃-C₂₂ cycloalkylene, C₆-C₂₂ arylene, C₇-C₂₂ alkylarylene, and mixture thereof; Y is —O—, NR′—, and mixtures thereof, R′ is hydrogen, C₁-C₄ alkyl, and mixtures thereof; p is 0 or 1.

3. A process according to claim 2 wherein Y is —NH—, and each p is 1.

4. A process according to claim 3 wherein R³ is C₂-C₆ alkylene, phenylene, C₇-C₁₀ alkylarylene, and mixture thereof.

5. A process according to claim 1 wherein said fabric reactive moiety is independently selected from the group consisting of halogen, thioglycolate, citrate, nicotinate, (4-sulfonylphenyl)amino, (4-sulfonylphenyl)oxy, and mixtures thereof.

6. A process according to claim 1 wherein said fabric modifying compound has the formula: 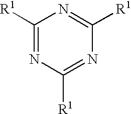
wherein R¹ is a fabric reactive moiety selected from the group consisting of halogen, thioglycolate, citrate, nicotinate, (4-sulfonylphenyl)amino, (4-sulfonylphenyl)oxy, and mixtures thereof.

7. A process according to claim 6 wherein said fabric modifying compound has the formula:

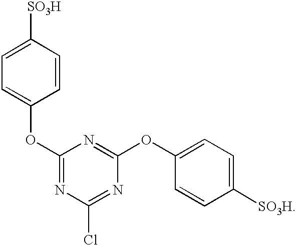

8. A process according to claim 1 wherein said fabric modifying compound has the formula: 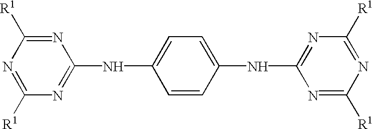
wherein R¹ is a fabric reactive moiety selected from the group consisting of halogen, thioglycolate, citrate, nicotinate, (4-sulfonylphenyl)amino, (4-sulfonylphenyl)oxy, and mixtures thereof.

9. A process according to claim 8 wherein said cellulose modifying compound has the formula:

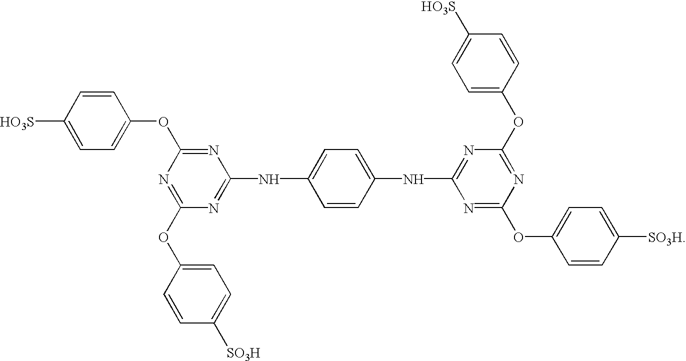

10. A process according to claim 8 wherein said cellulose modifying compound has the formula:

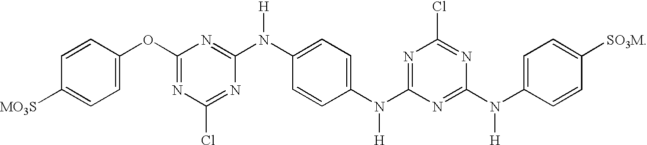

11. A composition for modifying cellulosic fabric, said composition comprising:
a) from about 0.1% to about 20% by weight, of a fabric modifying compound having the formula: 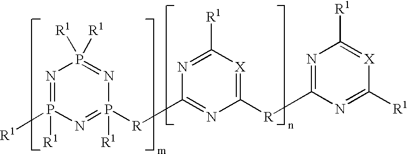
wherein R is a backbone linking unit; each R¹ is independently
i) a fabric reactive moiety;
ii) a polysaccharide unit;
iii) s-triazine units having the formula: 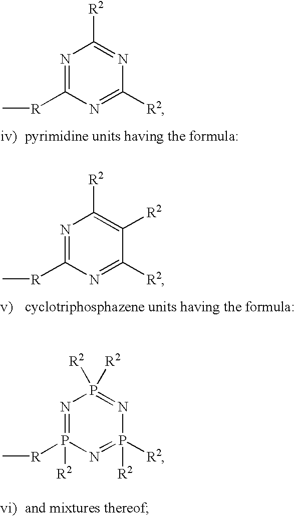
wherein R² is hydrogen, C₁-C₄ alkyl, or R¹; X is —N—, —CH—, or mixtures thereof;
the index m is from 0 to 5, the index n is from 0 to 5;
b) from about 0.01% to about 10% by weight, of a crosslinking catalyst; and
c) the balance carriers and other adjunct ingredients.

12. A composition according to claim 11 comprising from about 1% to about 10% by weight, of said cellulose modifying compound.

13. A composition according to claim 12 comprising from about 3% to about 7% by weight, of said cellulose modifying compound.

14. A composition according to claim 11 wherein said crosslinking catalyst is a base catalyst.

15. A composition according to claim 14 wherein said crosslinking catalyst is a base selected from the group consisting of alkali metal carbonates, alkaline earth metal carbonates, alkali metal hydroxides, alkaline earth metal hydroxides, and mixtures thereof.

16. A composition according to claim 15 wherein said catalyst is sodium carbonate.

17. A composition according to claim 11 wherein each R is independently a unit having the formula:
—(Y)ₚR³(Y)ₚ—
wherein R³ is C₁-C₂₂ alkylene, C₁-C₂₂ alkenylene, C₃-C₂₂ cycloalkylene, C₆-C₂₂ arylene, C₇-C₂₂ alkylarylene, and mixture thereof; Y is —O—, NR′—, and mixtures thereof, R′ is hydrogen, C₁-C₄ alkyl, and mixtures thereof; p is 0 or 1.

18. A composition according to claim 17 wherein Y is —NH—, and each p is 1.

19. A composition according to claim 18 wherein R³ is C₂-C₆ alkylene, phenylene, C₇-C₁₀ alkylarylene, and mixture thereof.

20. A composition according to claim 11 wherein said cellulose reactive moiety is independently selected from the group consisting of halogen, thioglycolate, citrate, nicotinate, (4-sulfonylphenyl)amino, (4-sulfonylphenyl)oxy, and mixtures thereof.

21. A composition according to claim 11 wherein said fabric modifying compound has the formula: 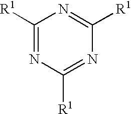
wherein R¹ is a fabric reactive moiety selected from the group consisting of halogen, thioglycolate, citrate, nicotinate, (4-sulfonylphenyl)amino, (4-sulfonylphenyl)oxy, and mixtures thereof.

22. A composition according to claim 21 wherein said fabric modifying compound has the formula:

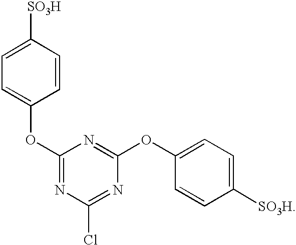

23. A composition according to claim 11 wherein said fabric modifying compound has the formula: 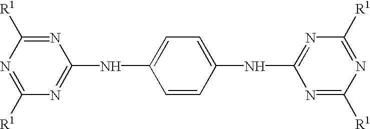
wherein R¹ is a fabric reactive moiety selected from the group consisting of halogen, thioglycolate, citrate, nicotinate, (4-sulfonylphenyl)amino, (4-sulfonylphenyl)oxy, and mixtures thereof.

24. A composition according to claim 23 wherein said cellulose modifying compound has the formula:

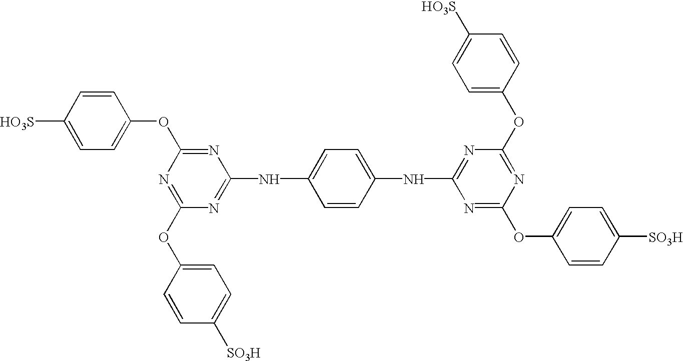

25. A composition according to claim 23 wherein said cellulose modifying compound has the formula: [chemical structure]
